(19) United States
(12) Patent Application Publication
(10) Pub. No.: US 2026/0045727 A1
(43) Pub. Date: Feb. 12, 2026

(54) HIGH-SPEED CONNECTOR AND MANUFACTURING METHOD THEREOF

(71) Applicant: BIZLINK INTERNATIONAL CORP., New Taipei City (TW)

(72) Inventor: Guang Zong HU, New Taipei City (TW)

(21) Appl. No.: 18/800,127

(22) Filed: Aug. 12, 2024

(51) Int. Cl. H01R 13/502; H01R 12/72; H01R 13/405; H01R 43/20; H01R 107/00

(52) U.S. Cl. CPC H01R 13/502; H01R 12/721; H01R 13/405; H01R 43/205; H01R 2107/00

(57) ABSTRACT

A high-speed connector includes a housing, a circuit board, two signal wires, an inner mold and a spacer module. The circuit board is disposed in an internal space of the housing. The two signal wires are electrically connected to an upper surface and a lower surface of the circuit board, respectively. The inner mold is filled into the internal space of the housing and encloses a portion of the circuit board and the two signal wires. The spacer module is formed of an electrically insulated material and includes an upper spacer, a lower spacer and an interconnection element. The upper spacer is inserted between a first signal wire and the upper surface of the circuit board. The lower spacer is inserted between a second signal wire and the lower surface of the circuit board. The interconnection element connects the upper spacer to the lower spacer.

### BACKGROUND

### Technical Field

The present disclosure relates to a high-speed connector and a manufacturing method thereof.

### Description of Related Art

Prior art document CN111952817B discloses a high-speed connector including a circuit board, a number of cables soldered on the circuit board and an inner film covering a portion of the circuit board and the cable to protect the same. The prior art document, however, does not address the issue of signal interference between the circuit board and the cables.

### SUMMARY

An aspect of the disclosure is to provide a high-speed connector with reduced signal interference and high reliability, and to also provide a method of manufacturing the high-speed connector.

In accordance with an embodiment of the present disclosure, a high-speed connector includes a housing, a circuit board, a first signal wire, a second signal wire, an inner mold and a spacer module. The housing has an internal space. At least a portion of the circuit board is disposed in the internal space of the housing and has an upper surface and a lower surface. The first signal wire is electrically connected to the upper surface of the circuit board. The second signal wire is electrically connected to the lower surface of the circuit board. The inner mold is filled into the internal space of the housing and encloses a portion of the circuit board, the first signal wire and the second signal wire. The spacer module is formed of an electrically insulated material and includes an upper spacer, a lower spacer and an interconnection element. The upper spacer is inserted between the first signal wire and the upper surface of the circuit board. The lower spacer is inserted between the second signal wire and the lower surface of the circuit board. The interconnection element connects the upper spacer to the lower spacer.

In accordance with an embodiment of the present disclosure, a method of manufacturing a high-speed connector includes: (A) attaching a first signal wire and a second signal wire to an upper surface and a lower surface of a circuit board, respectively; (B) placing the circuit board in an internal space of a housing; (C) combining the circuit board with a spacer module formed of an electrically insulated material, in which the spacer module includes an upper spacer, a lower spacer and an interconnection element, the upper spacer is inserted between the first signal wire and the upper surface of the circuit board, the lower spacer is inserted between the second signal wire and the lower surface of the circuit board; and (D) after completion of steps (A), (B) and (C), filling the internal space of the housing with an inner mold to enclose a portion of the circuit board, the first signal wire and the second signal wire.

### BRIEF DESCRIPTION OF THE DRAWINGS

To make the objectives, features, advantages, and embodiments of the present disclosure, including those mentioned above and others, more comprehensible, descriptions of the accompanying drawings are provided as follows.

FIGS. 1 and 2 illustrate perspective views of a high-speed connector in accordance with an embodiment of the present disclosure;

FIG. 3 illustrates an exploded view of the high-speed connector shown in FIG. 1, in which the side cover and the inner mold are omitted;

FIGS. 4 and 5 illustrate cross-sectional views of the high-speed connector shown in FIG. 2 taken along the line segments 4-4′ and 5-5′, respectively;

FIG. 6 illustrates a perspective views of a high-speed connector in accordance with another embodiment of the present disclosure; and

FIG. 7 illustrates a cross-sectional view of the high-speed connector shown in FIG. 6 taken along the line segment 7-7′.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

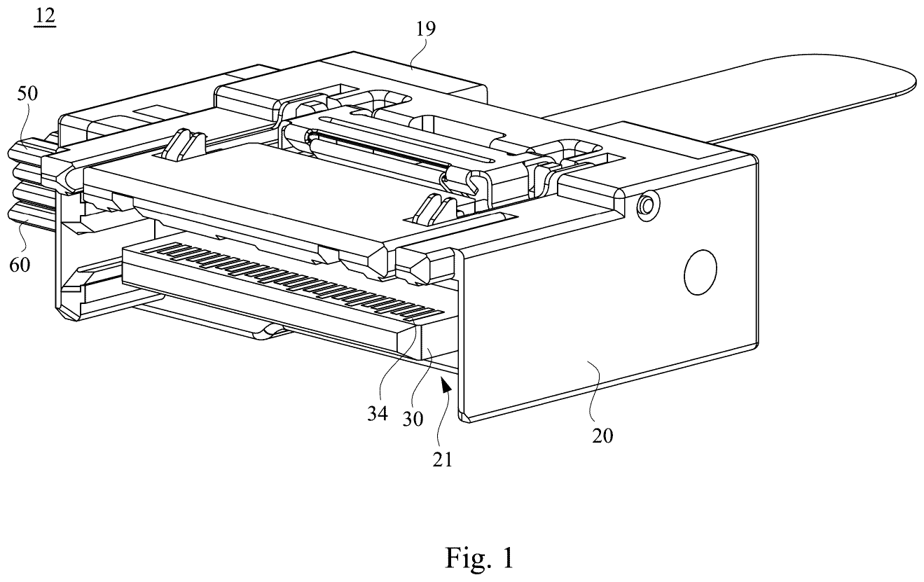

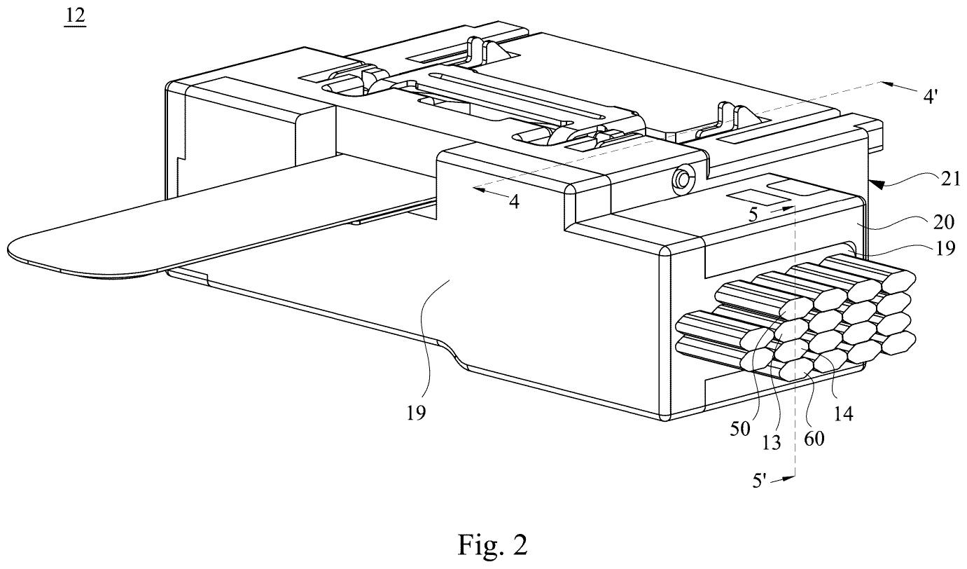

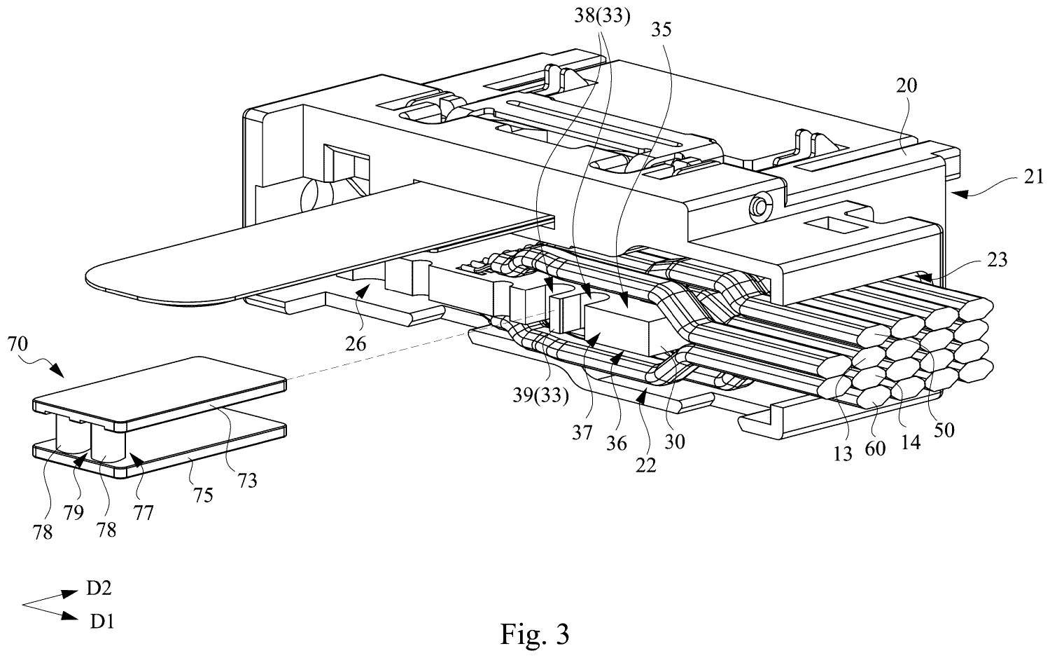

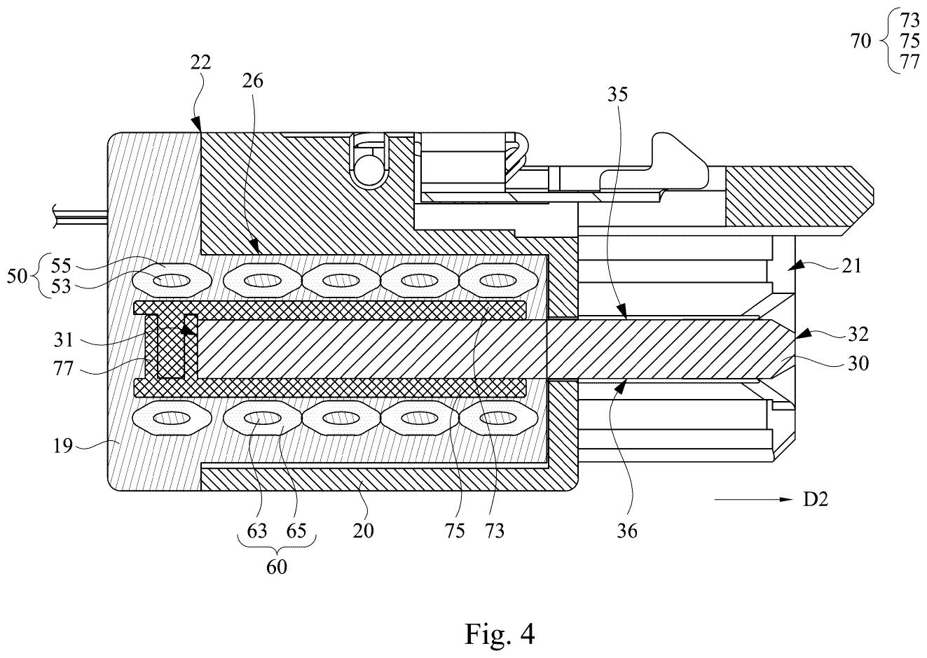

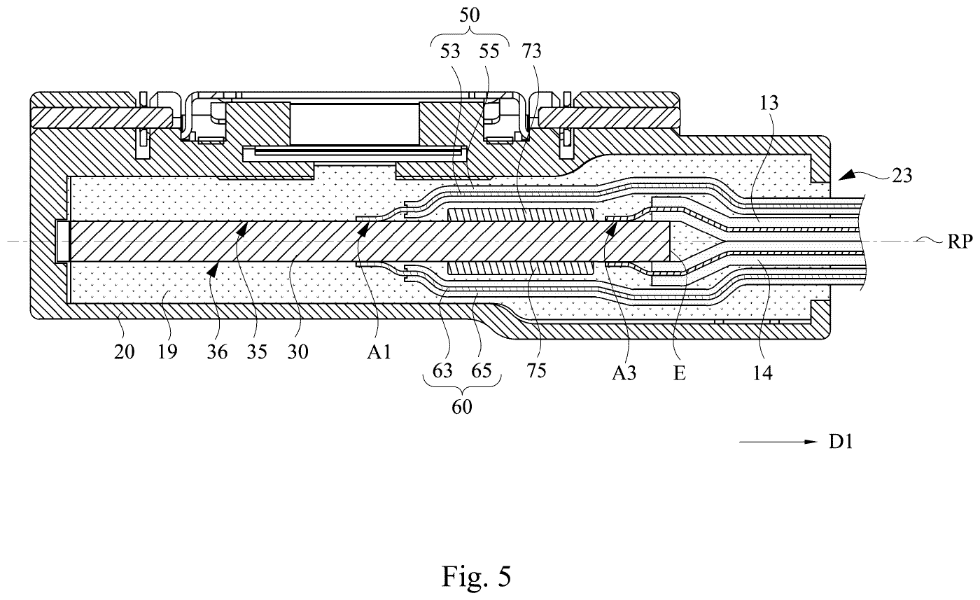

It is noted that FIGS. 1 to 7 of the drawings are drawn according to actual scales. For the conciseness of the specification, the size of each element is not described herein. However, the size and position of each element, as depicted in the drawings, should be considered as being part of the present disclosure.

The present disclosure relates to a high-speed (electrical) connector and a manufacturing method thereof. Specifically, the high-speed connector of the present disclosure is a wire-end connector that can be connected to one or more electronic devices, such as personal computers or servers, to enable high bandwidth data transmission from and to the electronic devices. In some embodiments, the high-speed connector of the present disclosure can be an MCIO connector or a GEN-Z connector.

As shown in FIGS. 1 to 5, a high-speed connector 12 in accordance with a first embodiment of the present disclosure includes a housing 20, a circuit board 30, at least one first signal wire 50, at least one second signal wire 60, an inner mold 19 and a spacer module 70.

As shown in FIGS. 1 to 5, the housing 20 is a hollow element with an internal space 26. The housing 20 also has a front opening 21, a rear opening 22 and a side opening 23. The front opening 21, the rear opening 22 and the side opening 23 communicate with the internal space 26.

As shown in FIGS. 1 to 5, the circuit board 30 has an upper surface 35 and a lower surface 36. The lower surface 36 is opposite to the upper surface 35. In addition, the circuit board 30 includes a plurality of electrical contacts 34 disposed on at least one of the upper surface 35 and the lower surface 36. The circuit board 30 is, for example, a printed circuit board (PCB).

As shown in FIGS. 1 to 5, the first signal wire 50 and the second signal wire 60 are configured to transmit electronic signals. Each of at least one the first signal wire 50 includes a first conductive core 53 and a first sheath 55 wrapping around the first conductive core 53. Each of the at least one second signal wire 60 includes a second conductive core 63 and a second sheath 65 wrapping around the second conductive core 63. The first sheath 55 and the second sheath 65 are formed of an electrically insulated material, such as a polymer material. In the illustrated embodiment, the high-speed connector 12 includes a plurality of first signal wires 50 and a plurality of second signal wires 60 arranged in two separate rows.

As shown in FIGS. 1 to 5, the spacer module 70 is formed of an electrically insulated material, such as a polymer material, and includes an upper spacer 73, a lower spacer 75 and an interconnection element 77. The interconnection element 77 connects the upper spacer 73 to the lower spacer 75. In the present embodiment, the upper spacer 73 and the lower spacer 75 are provided on two opposite sides of the interconnection element 77, such that the upper spacer 73, the lower spacer 75 and the interconnection element 77 collectively form a C-shaped structure. The spacer module 70 may be a unitary body. In other words, the upper spacer 73, the lower spacer 75 and the interconnection element 77 are integrally formed. Alternatively, the spacer module 70 can be an assembly of two or more parts. The two or more parts can be joined by one or more fasteners, such as screws. In some embodiments, the spacer module 70 can be formed by injection molding.

As shown in FIGS. 1 to 5, at least a portion of the circuit board 30 is disposed in the internal space 26 of the housing 20. The electrical contacts 34 of the circuit board 30 are exposed through the front opening 21, such that the electrical contacts 34 can be joined with an external connector to create an electrical connection between the circuit board 30 and the external connector for signal transmission.

As shown in FIGS. 1 to 5, the first signal wire 50 and the second signal wire 60 partially extend into the internal space 26 of the housing 20 via the side opening 23. The first conductive core 53 of the first signal wire 50 is attached to the upper surface 35 of the circuit board 30 and is electrically connected to the upper surface 35 of the circuit board 30. The second conductive core 63 of the second signal wire 60 is attached to the lower surface 36 of the circuit board 30 and is electrically connected to the lower surface 36 of the circuit board 30. In some embodiments, the first signal wire 50 and the second signal wire 60 are attached to the circuit board 30 by means of soldering.

As shown in FIGS. 1 to 5, the spacer module 70 is disposed in the internal space 26 of the housing 20. The spacer module 70 is attached to the circuit board 30 and faces the rear opening 22 of the housing 20, which is opposite to the front opening 21 of the housing 20. The upper spacer 73 is inserted between the first sheath 55 of the first signal wire 50 and the upper surface 35 of the circuit board 30. The lower spacer 75 is inserted between the second sheath 65 of the second signal wire 60 and the lower surface 36 of the circuit board 30. The interconnection element 77 extends from the upper surface 35 to the lower surface 36 to connect the upper spacer 73 to the lower spacer 75. In some embodiments, the interconnection element 77 abuts against a lateral surface 37 of the circuit board 30, which is between the upper surface 35 and the lower surface 36 and faces the rear opening 22.

As shown in FIGS. 1 to 5, the inner mold 19 is filled into the internal space 26 of the housing 20 and encloses a portion of the circuit board 30 and a portion of the first signal wire 50 and the second signal wire 60 that extend into the internal space 26 of the housing 20. In the present embodiment, the inner mold 19 also encloses the spacer module 70 and covers the rear opening 22 and the side opening 23. The inner mold 19 is formed of an electrically insulated material, such as a polymer material. The inner mold 19 can protect the solder joints of the signal wires. In some embodiments, the inner mold 19 can be formed using an injection molding process.

The spacer module 70 can separate the first signal wire 50 and the second signal wire 60 from the surfaces of the circuit board 30 to effectively prevent signal interference between the signal wires and the conductive traces of the circuit board 30. The spacer module 70 can be easily assembled with the circuit board 30, and the spacer module 70 can stably stay between the signal wires and the circuit board 30 during the injection molding process for creating the inner mold 19, such that the high-speed connector 12 can have improved reliability.

As shown in FIGS. 1 to 5, in some embodiments, the upper spacer 73 and the lower spacer 75 extend in a transverse direction of the first signal wire 50 and the second signal wire 60. In other words, the first signal wire 50 and the second signal wire 60 extend in a first direction D1, and the upper spacer 73 and the lower spacer 75 extend in a second direction D2 transverse to the first direction D1.

As shown in FIGS. 1 to 5, in some embodiments, the circuit board 30 has a first lateral side 31 and a second lateral side 32. The first lateral side 31 and the second lateral side 32 are substantially parallel to the first signal wire 50 and the second signal wire 60. In the illustrated embodiment, the first lateral side 31 faces the rear opening 22 of the housing 20, and the second lateral side 32 faces the front opening 21 of the housing 20. The interconnection element 77 of the spacer module 70 is provided on the first lateral side 31, and the upper spacer 73 and the lower spacer 75 extend from the first lateral side 31 towards the second lateral side 32. In some embodiments, the spacer module 70 can be laterally inserted into the housing 20 via the rear opening 22.

As shown in FIGS. 1 to 5, in some embodiments, the circuit board 30 further includes a mating structure 33 mating with the interconnection element 77 of the spacer module 70. In some embodiments, the mating structure 33 includes at least one of a recess 38 and a protrusion 39, and the mating structure 33 and the interconnection element 77 have complementary shapes. In the illustrated embodiment, the interconnection element 77 includes two posts 78 separated by a gap 79. The circuit board 30 has two recesses 38 on an edge of the circuit board 30. The two recesses 38 can each receive one of the two posts 78, and the protrusion 39 between the two recesses 38 can be inserted into the gap 79.

As shown in FIGS. 1 to 5, in some embodiments, the high-speed connector 12 further includes at least one third signal wire 13 attached to a third location A3 on the upper surface 35 of the circuit board 30. The third location A3 is next to an edge E of the circuit board 30. The first signal wire 50 is attached to a first location A1 on the upper surface 35, which is farther away from the edge E then the third location A3. The upper spacer 73 is provided between the first location A1 and the third location A3 to separate the first signal wire 50 from the upper surface 35 of the circuit board 30. In some embodiments, the first signal wire 50 and the third signal wire 13 are in a stack arrangement.

As shown in FIGS. 1 to 5, in some embodiments, the high-speed connector 12 further includes at least one fourth signal wire 14 attached to the lower surface 36 of the circuit board 30. In some embodiments, the fourth signal wire 14, the second signal wire 60 and the lower spacer 75 are symmetrical to the third signal wire 13, the first signal wire 50 and the upper spacer 73 with respect to a reference plane RP.

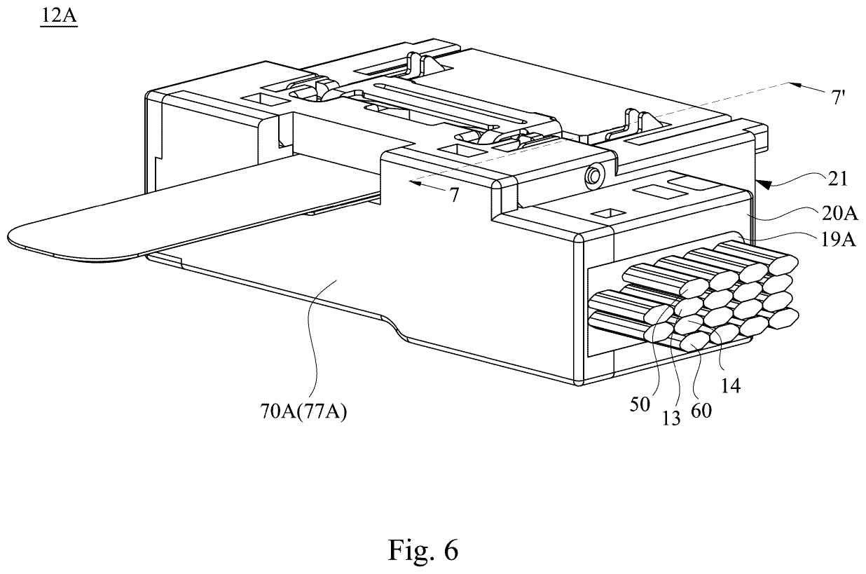

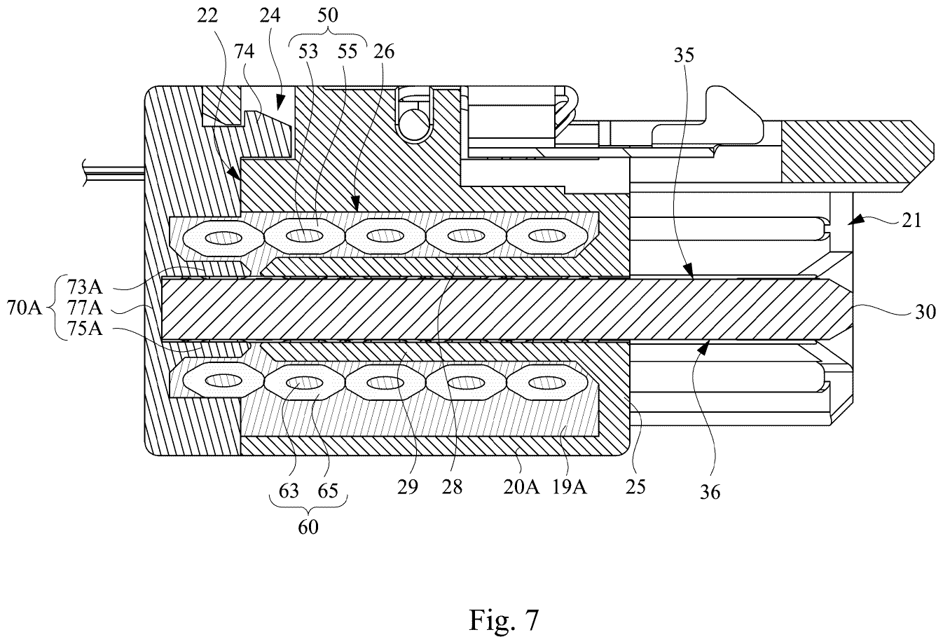

As shown in FIGS. 6 and 7, a high-speed connector 12A in accordance with a second embodiment of the present disclosure includes a housing 20A, a circuit board 30, at least one first signal wire 50, at least one second signal wire 60, an inner mold 19A and a spacer module 70A. The spacer module 70A differs from the spacer module 70 of the first embodiment in that the interconnection element 77A is disposed on a side of the housing 20A and covers the rear opening 22 of the housing 20A. The upper spacer 73A and the lower spacer 75A project from the interconnection element 77A and extend into the internal space 26 of the housing 20A. As with the first embodiment, the upper spacer 73A inserted is between the first signal wire 50 and the upper surface 35 of the circuit board 30, and the lower spacer 75A is inserted between the second signal wire 60 and the lower surface 36 of the circuit board 30. Moreover, in the present embodiment, the inner mold 19A is confined in the internal space 26 of the housing 20A and is covered by the interconnection element 77A.

As shown in FIGS. 6 and 7, in some embodiments, the housing 20A includes at least one first engaging structure 24. The interconnection element 77A includes at least one second engaging structure 74 engaging the first engaging structure 24 to attach the spacer module 70A to the housing 20A. The first engaging structure 24 can include at least one slot, and the second engaging structure 74 can include at least one snap feature.

As shown in FIGS. 6 and 7, in some embodiments, the housing 20A further includes a first spacer structure 28 extending between the first sheath 55 of the first signal wire 50 and the upper surface 35 of the circuit board 30. In some embodiments, the housing 20A further includes a second spacer structure 29 extending between the second sheath 65 of the second signal wire 60 and the lower surface 36 of the circuit board 30. The first spacer structure 28 and the second spacer structure 29 can also prevent signal interference between the signal wires and the conductive traces of the circuit board 30. In some embodiments, the housing 20A further includes an inner partition 25 between the front opening 21 and the rear opening 22. The circuit board 30 extends through the inner partition 25. The first and second spacer structures 28 and 29 project from the inner partition 25 and extend towards the spacer module 70A.

In accordance with an embodiment of the present disclosure, a method of manufacturing a high-speed connector (e.g., the high-speed connectors 12 or 12A mentioned above) includes: (A) attaching a first signal wire and a second signal wire (e.g., the first and second wires 50 and 60 mentioned above) to an upper surface and a lower surface of a circuit board (e.g., the circuit board 30 mentioned above), respectively; (B) placing the circuit board in an internal space of a housing (e.g., the housing 20 or 20A mentioned above); (C) combining the circuit board with a spacer module formed of an electrically insulated material, in which the spacer module (e.g., the spacer module 70 or 70A mentioned above) includes an upper spacer, a lower spacer and an interconnection element, the upper spacer is inserted between the first signal wire and the upper surface of the circuit board, the lower spacer is inserted between the second signal wire and the lower surface of the circuit board; and (D) after completion of steps (A), (B) and (C), filling the internal space of the housing with an inner mold (e.g., the inner mold 19 or 19A mentioned above) to enclose a portion of the circuit board, the first signal wire and the second signal wire.

In sum, the high-speed connector of the present disclosure includes a spacer module that is attached to the circuit board of the connector and separate two rows of the signal wires on opposite faces of the circuit board from the circuit board, so as to prevent signal interference between the signal wires and the conductive traces of the circuit board. The spacer module can be easily assembled with the circuit board, and the spacer module can stably stay between the signal wires and the circuit board during the injection molding process for creating the inner mold, such that the high-speed connector can have improved reliability.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A high-speed connector, comprising:
a housing having an internal space;
a circuit board, at least a portion of the circuit board being disposed in the internal space of the housing and having an upper surface and a lower surface;
a first signal wire being electrically connected to the upper surface of the circuit board;
a second signal wire being electrically connected to the lower surface of the circuit board;
an inner mold filled into the internal space of the housing and encloses a portion of the circuit board, the first signal wire and the second signal wire; and
a spacer module formed of an electrically insulated material and comprising an upper spacer, a lower spacer and an interconnection element,
wherein the upper spacer is inserted between the first signal wire and the upper surface of the circuit board, the lower spacer is inserted between the second signal wire and the lower surface of the circuit board, and the interconnection element connecting the upper spacer to the lower spacer.

2. The high-speed connector of claim 1, wherein the circuit board has a first lateral side and a second lateral side, the first lateral side and the second lateral side are substantially parallel to the first signal wire and the second signal wire, the interconnection element of the spacer module is provided on the first lateral side, and the upper spacer and the lower spacer extend from the first lateral side towards the second lateral side.

3. The high-speed connector of claim 1, wherein the upper spacer and the lower spacer extend in a transverse direction of the first signal wire and the second signal wire.

4. The high-speed connector of claim 1, wherein the interconnection element of the spacer module abuts against a lateral surface of the circuit board, the lateral surface is between the upper surface and the lower surface.

5. The high-speed connector of claim 1, wherein the housing further has an opening communicating with the internal space, the spacer module is attached to the circuit board and faces the opening, wherein the inner mold encloses the spacer module and covers the opening.

6. The high-speed connector of claim 5, wherein the upper spacer and the lower spacer are provided on two opposite sides of the interconnection element, such that the upper spacer, the lower spacer and the interconnection element collectively form a C-shaped structure.

7. The high-speed connector of claim 5, wherein the circuit board comprises a mating structure mating with the interconnection element of the spacer module.

8. The high-speed connector of claim 7, wherein the mating structure comprises at least one of a recess and a protrusion, and the mating structure and the interconnection element have complementary shapes.

9. The high-speed connector of claim 1, wherein the housing further has an opening communicating with the internal space, the interconnection element of the spacer module covers the opening of the housing, and the upper spacer and the lower spacer project from the interconnection element.

10. The high-speed connector of claim 1, wherein the spacer module is a unitary body or is an assembly of two or more parts.

11. The high-speed connector of claim 1, further comprising a third signal wire attached to a third location on the upper surface of the circuit board, the third location being next to an edge of the circuit board, wherein the first signal wire is attached to a first location on the upper surface, the first location is farther away from the edge then the third location, wherein the upper spacer is provided between the first location and the third location.

12. A method of manufacturing a high-speed connector, comprising:
(A) attaching a first signal wire and a second signal wire to an upper surface and a lower surface of a circuit board, respectively;
(B) placing the circuit board in an internal space of a housing;
(C) combining the circuit board with a spacer module formed of an electrically insulated material, wherein the spacer module comprises an upper spacer, a lower spacer and an interconnection element, the upper spacer is inserted between the first signal wire and the upper surface of the circuit board, the lower spacer is inserted between the second signal wire and the lower surface of the circuit board; and
(D) after completion of steps (A), (B) and (C), filling the internal space of the housing with an inner mold to enclose a portion of the circuit board, the first signal wire and the second signal wire.

13. The method of claim 12, wherein the inner mold is formed by injection molding in step (D).

14. The method of claim 12, wherein the housing has an opening communicating with the internal space, in step (C), the spacer module is inserted into the internal space via the opening to combine with the circuit board, and in step (D), the inner mold encloses the spacer module and covers the opening.

15. The method of claim 12, wherein the housing has an opening communicating with the internal space, in step (C), the interconnection element of the spacer module is attached to the housing to cover the opening of the housing, and in step (D), the inner mold is confined in the internal space of the housing.
